(19) United States
(12) Patent Application Publication
(10) Pub. No.: US 2003/0002940 A1
(43) Pub. Date: Jan. 2, 2003

(54) Rotary drilling and cutting tools for manufacturing printed circuit boards

(76) Inventors: Andrew J. Forth, Carlsbad, CA (US); Tim L. Taylor, Corona Del Mar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/112,959

(22) Filed: Mar. 28, 2002

Related U.S. Application Data
(63) Continuation of application No. 09/595,155, filed on Jun. 16, 2000, now abandoned.

(51) Int. Cl. B23B 51/02

(52) U.S. Cl. 408/226; 76/108.6

(57) ABSTRACT

Carbide drilling and cutting tools for use in manufacturing printed circuit boards are provided by a process that recycles used tools as the starting raw materials. The used tools have a working portion and shank with a diameter of, for example, approximately 0.125 inches. The working portion of the used tool is removed and a new carbide head is attached to the remaining shank. The new carbide head, which also has a diameter of approximately 0.125 inches, is then machined to create a new working portion. The new tool is distributed for use and then recovered after use for recycling and manufacture of new tools from the shanks of the recycled tools.

This application is a continuation of U.S. application Ser. No. 09/595,155, filed on Jun. 16, 2000.

### BACKGROUND OF THE INVENTION

1. Field of the Invention

The present invention relates to drilling and cutting tools designed for use in automatic tool-changing equipment and, more particularly, to drilling and cutting tools of small sizes, and methods of manufacturing them from recycled carbide tools, for use in the production of printed circuit boards.

1. Description of the Related Art

Printed circuit boards (“PCBs”) are used in computers, cellular telephones, automobiles, machine controllers and virtually every type of electronic device. One step in the manufacture of PCBs is the drilling of small diameter holes. These holes are subsequently electroplated with copper, providing electrical conductance between layers of circuitry. PCB holes typically range in diameter from about 0.0040 to 0.3000 inches. However, approximately 98% of the PCB holes are drilled to a diameter that is smaller than 0.125 inches (i.e., less than ⅛ inch).

At present, the vast majority of holes that are mechanically formed are drilled with carbide drilling tools or “drill bits.”The machines used for drilling holes in PCBs with these drill bits are high-speed, high precision, computer-controlled drilling machines. These machines are capable of drilling up to 400 holes per minute, with 0.0001 inch movement accuracy. Typical drilling machines have high-speed, air-bearing spindles that use draw-bar collets for holding the drill bit. In order to standardize and maximize the speed of the drilling process, the collets have standard internal diameters that accept drill bits having shanks with a uniform diameter of 0.125 inches, with a typical tolerance of +0.0000 inches, −0.0005 inches. Drill bits of this type are said to have “common diameter” ⅛ inch shanks.

Drill bit design and manufacturing methods in the PCB industry are currently divided into two basic categories: drill bits whose drilling diameter is equal to or smaller than 0.125 inches, and drill bits whose drilling diameter is greater than 0.125 inches. Over the years, a variety of manufacturing methods have been used to manufacture these types of drill bits.

For example, in the 1960s, before the standardization to drill bits having common diameter shanks, drill bits in both categories were made from a solid piece of carbide in which the drilling diameter was the same as the shank diameter.

In the 1970s, when common diameter shanks came into acceptance, bits having a drilling diameter equal to or smaller than 0.125 inches were made from a solid piece of carbide or cylindrical “blank” having a uniform starting diameter of 0.125 inches (i.e., the diameter before plunge grinding). In these “solid carbide” bits, as shown in FIG. 5, the drilling diameter was machined from a solid “blank” 10 to a desired size using a plunge grind technique, leaving a working portion 12 and a shank 14 with a diameter at the desired 0.125 inches. For drill bits having a drilling diameter larger than 0.125 inches, a larger diameter blank of appropriate size was machined to the desired drilling diameter, and the shank was machined to the 0.125 inch common shank diameter.

In addition, for bits having a drilling diameter greater than 0.125 inches, it was known by the 1980s to braze a 0.125 inch diameter carbide shank to a larger diameter carbide head for subsequent machining to a desired drilling diameter. In some instances, these shanks were taken from previously used solid carbide bits having a common shank diameter of 0.125 inches and a drilling diameter equal to or smaller than 0.125 inches.

In the prior methods for manufacturing drill bits having a drilling diameter equal to or smaller than 0.125 inches, in order to minimize the use of expensive carbide, common diameter shanks made of various other materials were joined to previously machined carbide drilling portions of sizes ranging from about 0.0400 inches to 0.0600 inches. These prior attachment methods have been primarily limited to attaching a 0.125 inch non-carbide shank to a carbide head having a diameter of about 0.0600 inches or less. Accordingly, this has restricted the drilling diameters to about 0.0600 inches and smaller.

For example, by the mid-1970s, 0.125 inch stainless steel shanks were joined to various sized drilling portions, typically between about 0.0400 inches to 0.0600 inches, either through brazing, use of an adhesive or a press/shrink fit. Another method for this smaller size drill bit utilized a injection molded fiberglass reinforced plastic shank connected to a previously machined carbide drilling portion. Through these methods, the use of less expensive non-carbide shanks could reduce the overall cost of the bit, particularly the cost of raw materials.

In addition to drilling holes, the PCB manufacturing process requires the use of router bits to machine the final dimensions of the PCBs. In this regard, PCBs are usually made in a multiple image formats on a standard panel size, and then cut by router bits into smaller dimensions. In these applications, the router bits are designed to be both end and side cutting. In other words, they drill holes through the panels and then cut the panels using the sides of the bit.

Smaller slots that range from about 0.0625 inches in width and 0.25 inches in length, to about 0.25 inches in width and 5 inches in length, as well as other sizes, may be machined with a slot drill bit, instead of with a router bit. Slot drills are drills with a stronger geometry and are designed to gradually “drill out” the length of the slot. This is done in a well known manner by drilling multiple holes to produce a continuous slot.

Router bits have been made in the past with a solid carbide construction. In the 1960s, the cutting diameters and shank diameters of most bits were the same size. Today, the vast majority of router bits are smaller than 0.125 inches in cutting diameter and have a 0.125 inch common diameter shank, in which the entire bit is manufactured from a single piece of solid carbide.

One of the problems in manufacturing drill and router bits is the high cost. Within the PCB manufacturing industry, extremely hard drill and router bits are required to meet demanding manufacturing tolerances and specifications. However, suitably hard, durable bits, such as those made from carbide, have proven to be relatively expensive. The expense is primarily due to the large quantity of expensive carbide that is necessary to manufacture each bit.

For example, with drill bits having drilling diameters less than 0.125 inches, the actual working portion of the bit may constitute as little as 5%, or even less, of the total material in the bit. This is because the majority of the carbide is ground away in the tapering and fluting process that forms the small drilling diameter of the bit. The additional 95% of expensive bit material is necessary to provide a drill bit's shank with sufficient hardness, durability, dimensional stability and “common diameter” size to be compatible with precision collets. Such qualities are of special importance in the fine, precision drilling operations of the PCB industry, especially where automated high-speed drill-changing techniques are employed. Thus, through repeated use, the drilling portion of a bit wears, and when it becomes worn to the point that it can no longer be resharpened, it must be replaced for a new one. Consequently, the entire bit is normally recycled for use in other, unrelated carbide applications in spite of the shank having no defect.

As noted above, to avoid the high cost of expensive carbide shanks, common diameter shanks made of stainless steel, plastic and other less expensive materials have been used. While these alternatives have been somewhat effective to reduce the overall cost of the bits, they do not provide the same level of quality and performance associated with bits manufactured entirely from carbide. Moreover, these bit constructions also require additional manufacturing steps and have encountered difficulties in the manufacturing process.

Accordingly, there has existed a definite need for a method of manufacturing drill bits, router bits and other rotary drilling and cutting tools which is relatively simple to implement and reduces costs, yet still provides all of the quality and performance benefits of bits made entirely from carbide. The present invention satisfies these and other needs and provides further related advantages.

### SUMMARY OF THE INVENTION

The present invention provides rotary drilling and cutting tools of small sizes, such as drill and router bits, and methods of manufacturing them, for use in making high-precision holes and slots, such as those required in the production of printed circuit boards. In accordance with the invention, these bits are manufactured with recycled materials that are taken from previously used drill and router bits and other rotary tools. As explained below, the present invention provides these drill and router bits with all of the quality and performance benefits of bits made entirely from new materials, yet at significantly reduced costs.

In accordance with the invention, used carbide drill and router bits are recovered from service in the field after they have become worn and have reached the end of their useful life. These bits have a shank and a working portion that has been machined in a conventional manner to provide a uniform shank diameter, for example, 0.125 inches. After recovering the used bits, the working portion of each bit is removed, leaving only the shank.

In the preferred embodiment, the working portion is removed from the shank by a grinding process. Alternatively, the working portion can be removed by cutting the working portion from the shank. Moreover, when the bits are of the type manufactured according to the present invention, the working portion also can be removed by heating the bit to a sufficient temperature, and then pulling the working portion off of the shank.

In the next step of the process, a carbide head having substantially the same diameter as the shank (e.g., about 0.125 inches) is attached to the shank. In the preferred embodiment, the head is attached to the shank by brazing. The carbide head may be formed of a new piece of carbide or, alternatively, the carbide head may comprise the shank of a previously used bit.

Once the shank and head have been attached to each other, a new cylindrical two-piece “blank” is produced and ready to be made into a “new” carbide drilling or routing bit or similar rotary drilling or cutting tool. Accordingly, the cylindrical blank is plunged ground to the desired drilling or cutting diameter, followed by fluting and point machining. These well known grinding processes are performed on the head to produce the new working portion of the drill or router bit. It will be appreciated that the present invention is not limited to drill and router bits and is readily applicable to the manufacture of slot drills and other similar rotary drilling and cutting tools.

After the manufacturing process has been completed, the new tools are distributed for use in the field. When the tools have become worn and must be replaced, they are recovered and processed, as described above, to make additional “new” tools. This recovery and recycling process is preferably repeated multiple times to maximize savings.

The present invention has significant advantages over prior manufacturing methods for drilling and cutting tools having a diameter of 0.125 inches and smaller. These advantages include reducing the manufacturing, labor and material costs, increasing the accuracy of the joining assembly (i.e., the joint between the shank and the head), and providing for recycling of used drill, router, and similar cutting tool shanks.

By way of comparison, the common diameter shanks made of stainless steel are not recycled into new drill bits, and the separation of the carbide insert from the stainless steel shank is not cost effective or practical for recycling into other products. Furthermore, manufacturing costs associated with stainless steel shanks are higher, because there are additional grinding steps needed with the stainless steel assemblies. For example, after the insertion of the carbide insert into the stainless steel shank, the shank needs an additional, centerless grinding step in order to remove marks and deformities on the shank caused by the press fit insertion process.

In contrast, the present invention has greater accuracy of assembly, as compared to the stainless steel shank insertion process. For example, after insertion of a carbide head into a stainless steel shank using the press fit method, the eccentricity of alignment between the shank and the head is typically up to 0.0030 inches TIR, due in part to deformation of the insertion hole by the harder carbide insert head. In the case of the adhesive bond method, the eccentricity of alignment between the carbide head and the stainless steel shank also can be up to 0.0030 inches TIR, due in part to the annular gap between the outside diameter of the carbide head and the larger diameter hole in the stainless steel shank.

On the other hand, the joining of a 0.125 inch diameter carbide shank to a 0.125 inch diameter carbide head of the present invention produces higher joined accuracy of about 0.0003 inches TIR. In addition, because stainless steel is not as hard as carbide, the stainless steel shanks are more susceptible to scratches during manufacturing, thereby causing additional runout of the assembly and increased scrap. In contrast, the present invention produces finished tools of substantially greater concentricity and higher accuracy of performance, at a lower cost, while at the same time allowing recycling of the shanks multiple times.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a drill bit constructed in accordance with the present invention;

FIG. 2 is a perspective view of a router bit constructed in accordance with the present invention;

FIG. 3 is a flow chart illustrating further aspects of the process of manufacturing drill and router bits and other rotary drilling and cutting tools in accordance with the present invention;

FIG. 4 is a schematic illustration of one aspect of the method of the present invention for manufacturing a drill bit having a used carbide shank attached to a separate carbide head; and

FIG. 5 is a schematic illustration of a prior method of manufacturing a drill bit from a solid piece of carbide.

### DETAILED DESCRIPTION OF THE PREFERRED EMBODIMENTS

As shown in the exemplary drawings, the present invention is embodied in rotary drilling and cutting tools of small sizes, such as drill and router bits made of carbide, and methods of manufacturing them, for use in the production of printed circuit boards and the like. The raw materials used to manufacture these tools are provided by recovering previously used carbide tools that have been used in the field for their intended purpose, such as drilling holes and forming slots in printed circuit boards. When these used tools have been worn to the point they can no longer be resharpened, the conventional practice is to retire them from service and recycle them for use in other, unrelated carbide applications. However, as explained below, in accordance with the present invention, the used tools are retrieved from service and processed to manufacture an entirely new tool. In this way, a high quality tool can be manufactured entirely from carbide, and with increased accuracy, but at a fraction of the typical cost.

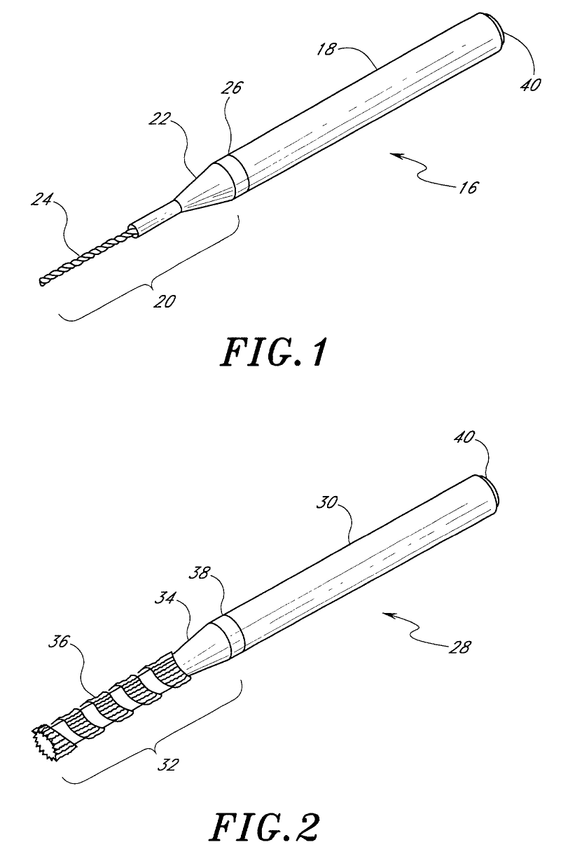

FIG. 1 illustrates a drill bit 16 constructed in accordance with the present invention. The drill bit 16 comprises a shank 18 and a separate working portion 20. The shank 18 is cylindrical in shape and has a substantially uniform diameter, for example, approximately 0.125 inches (i.e., ⅛ inch). The length of the shank 18 can vary according to the particular application at hand, but is typically between about 0.800 and 1.200 inches. The working portion 20 comprises a tapered section 22 and a fluted portion 24 having a desired flute length and drilling geometry. The shank is connected to the working portion at a joint 26.

FIG. 2 illustrates a router bit 28 constructed in accordance with the present invention. The router bit 28 comprises a shank 30 and a separate working portion 32. The shank 30 of the router bit 28 is essentially the same configuration as the shank 18 of the drill bit 16, described above. Hence, the shank 30 is cylindrical in shape, has a substantially uniform diameter (e.g., approximately 0.125 inches), and has a length of between about 0.800 and 1.200 inches. The working portion 32 comprises a tapered section 34 and a fluted portion 36 having a desired flute length and cutting geometry. The shank 30 and the working portion 32 are also connected at a joint 38.

The tools or “bits” manufactured in accordance with the invention are designed to be used in an automatic bit-changing machine. Accordingly, the end of each shank 18 and 30 is provided with a chamfer 40 designed to facilitate precise and accurate entrance and positioning of the shank in a precision collet of the automatic machine.

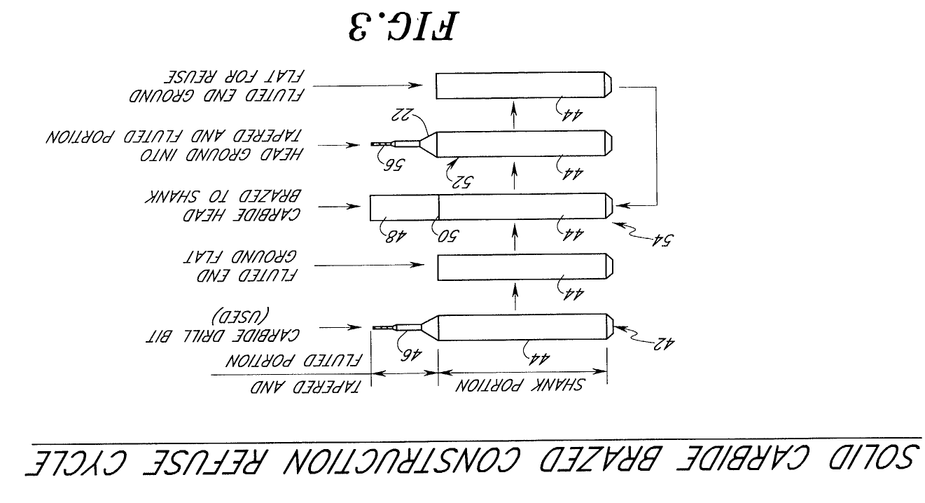

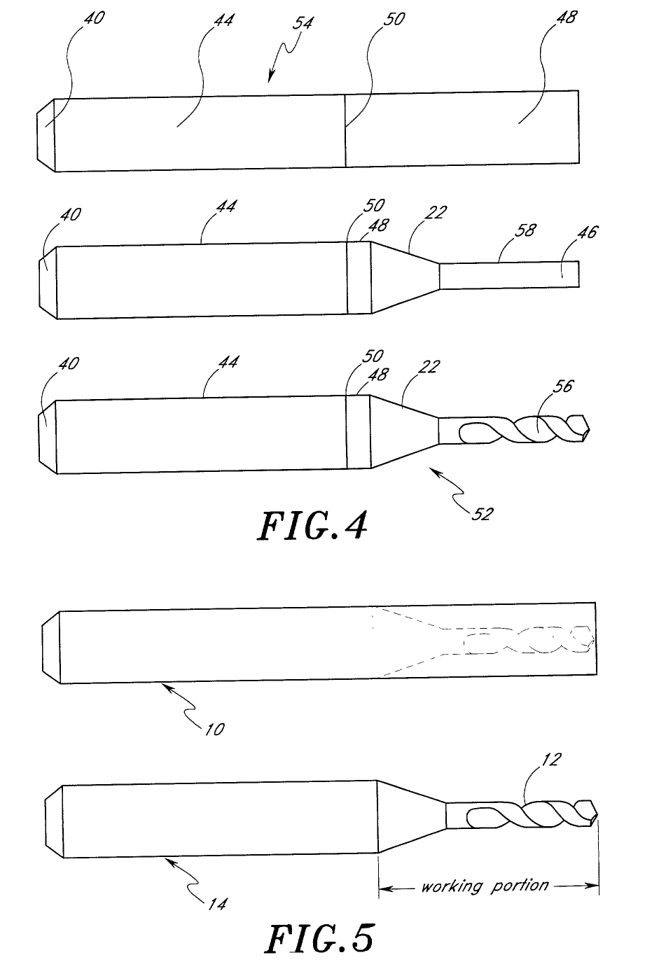

FIGS. 3 and 4 illustrate one preferred method of manufacturing tools according to the present invention. While FIGS. 3 and 4 illustrate the manufacture of a drill bit 16, it will be appreciated that the method is equally applicable to the manufacture of router bits 28 and other types of rotary drilling and cutting tools. Accordingly, it will be understood that the following description of manufacturing drill bits shall apply to the manufacture of such other tools.

In the first step of the process, used carbide drill bits 42 are recovered from service in the field. These used drill bits 42 have a shank 44 and a working portion 46 that have been machined in a conventional manner. For example, in one application of the invention, the shank 44 has been machined to a length of approximately 0.800-1.200 inches and to a diameter of about 0.125 inches. When the drill bit 42 is recovered from service, the working portion 46 normally has been used and worn such that it should no longer be used. However, unless the bit 42 has been damaged or mishandled, the shank 44 is not worn, having only been handled by the collet of the automated drilling machine. Thus, the shank 44 is entirely suitable for use as the shank of another drill bit.

After the used drill bits 42 have been recovered from the field, they are examined and any bits with defective shanks 44 are discarded. The remaining bits 42 are cleaned and processed for the next steps in the manufacturing process. The acceptable used bits 42 are loaded into a grinding machine and are ground to the desired shank length, which removes the working portion 46 of the used bit by grinding it away. Thus, at the end of the grinding process, only the shank 44 of the used bit 42 remains. In one of the preferred forms of the invention, the grinding machine also finishes the end of the shank 44 (opposite the chamfered end 40) so that it is relatively smooth and flat, for the joining process.

Alternatively, the working portion 46 of the used bit 42 can be removed by other methods. For example, the working portion 46 of the used bit 42 can be removed by a cutting process. In addition, when the used bit 42 is a bit manufactured according to the present invention, the working portion 46 also can be removed by heating the bit to a sufficient temperature and then pulling the working portion off of the shank 44.

In the next step, a cylindrical carbide head 48 is attached to the shank 44 of the used bit 42. The head 48 is attached to the end of the shank 44 opposite its chamfered end 40. In the preferred embodiment, the head 48 has substantially the same diameter as the shank 44 and is attached to the shank by brazing to form a joint 50. Brazing is the process of joining two pieces of metal by fusing a layer of spelter or a brass alloy between the adjoining surfaces without melting the parent metal of either piece. The filler material is normally drawn by capillary action into the space between the closely adjacent parts to be joined in the presence of heat at about 900° C. The adjoining surfaces are appropriately prepared to enhance the strength of the brazed joint 50.

It will be appreciated that other suitable methods for attaching a carbide head to a carbide shank may be used, and the present invention is not limited to any particular attachment method. For example, the shank 44 and head 48 may have complimentary mating conical or frustoconical surfaces. Other suitable geometrics can be used as desired or appropriate.

The carbide head 48 that is attached to the shank 44 may be a new carbide head, i.e., formed from a piece of fresh carbide that has never been used before as a drill bit. In these circumstances, the head must be machined and finished to substantially the same diameter as the shank (e.g., about 0.125 inches), from a raw carbide blank having a slightly larger diameter. This process of machining a blank to a finished diameter is a well known and conventional technique. Once the blank has been prepared in this manner, it is cut to provide new carbide heads of appropriate length. The length may be selected according to the particular requirements at hand and the application of the drill bit, but a typical length is between about 0.5-1.0 inch.

Alternatively, in accordance with one preferred form of the invention, the carbide head 48 is formed from the shanks 44 of the used drill bits 42. In this aspect of the invention, after the working portions 46 of the used drill bits 42 have been removed from their shanks 44, some of the shanks are set aside for use as the shanks 44 of the new drill bit 52 to be formed, and some of the shanks 44 are set aside for use as the heads 48 of the new drill bit 52. Because the shanks 44 in some cases are about twice the length necessary for use as the heads 48, the shanks that are set aside for use as the heads can be cut in half to provide two heads. In other cases, two used shanks 44 can be attached together to form a shank 44 and a head 48 which each have a length of about one inch.

In this aspect of the invention, the new drill bit 52 can be formed entirely from the shanks 44 of previously used carbide drill bits 42. This has the advantage of eliminating the machining and finishing steps associated with the manufacture of new heads 48 from raw carbide blanks. As noted above, the shanks 44 of the used drill bits 42 have already been machined and finished before these bits were put into service. As a result, the shanks 44 have a precise, finished surface and a diameter of, for example, approximately 0.125 inches. When these used shanks 44 are joined together to form a new blank 54 (i.e., shank 44 and head 48), they already have a finished cylindrical outer surface and have the substantially the same 0.125 inch diameter (within acceptable manufacturing tolerances). This significantly reduces the amount of time to manufacture the new drill bit 52, because it eliminates the extra machining and finishing steps associated with manufacturing blank heads 48 made from raw carbide. The elimination of these extra machining and finishing steps also reduces labor costs. Perhaps most significantly, however, there is no expense required to purchase expensive new carbide.

Once the shanks 44 and heads 48 have been attached to each other, an inventory of new cylindrical “blanks” 54 is produced and ready to be made into “new” carbide drilling bits 52. To this end, the blanks 54 are loaded into grinding machines that perform a sequence of further machining. The grinding machine holds or supports the shank 44 and performs several well known grinding processes on the head 48 to form the new working portion 56 of the drill bit 52, as shown in FIGS. 1, 3 and 4. As shown best in FIG. 4, these processes include plunge grinding the blank 54 to the appropriate drilling diameter 58, grinding a tapered transition 22 between the shank 44 and the head 48, grinding and tapering the flutes and tip of the working portion 56, and other conventional processes.

After the new drill bits 52 have been manufactured in accordance with the foregoing processes, they are sold and placed into service, for example, to drill holes in printed circuit boards. During use in the field, the working portions of the drill bits will become worn and eventually will be unsuitable for further use. When this happens, the used drill bits 42 are recovered and returned to the drill bit manufacturer for recycling in accordance with the manufacturing process described above.

The drill bits made according to this invention can be recovered and recycled multiple times. The more times they are recovered and recycled, the greater the savings. Accordingly, absent a defect in the shank, there is no limit to the number of times a used bit may be recycled so that its shank may be reused to make another bit.

As noted above, the method of manufacturing bits according to the present invention applies equally to drill bits 16 and 52, router bits 28, and similar types of rotary drilling and cutting tools. Of course, it will be appreciated that the grinding of the bit to form the working portion 32 of the router bit 28, as shown in FIG. 2, or other rotary tool, will be different depending on the type of tool involved.

Router bits 28 provide both end and side cutting functions. As a result, the bit 28 is side loaded in use when cutting slots. It is believed that, in the past, router bits 28 have never been made of a two-piece construction, primarily because of perceived concerns that the joint 38 would fail due to the side loading applied to the bit during use. However, the torsional and load strength provided by a brazed joint between adjoining carbide surfaces, in which a ⅛ inch diameter shank is brazed to a ⅛ inch diameter head, is quite exceptional.

It will be further appreciated that the present invention is not limited to tools having shank diameters of about 0.125 inches. For example, tools having different shank diameters, such as 3.00 mm (0.1181 inches) and 2.00 mm (0.0787 inches), also may be manufactured in accordance with the teachings of the invention. In these instances, the used tools that are recovered to manufacture these new tools will preferably have shank diameters of about 3.00 mm and 2.00 mm, respectively. Other shank diameters may be used as desired.

From the foregoing, it will be seen that the present invention has the advantages of producing finished tools having greater concentricity and higher accuracy of performance, lower material, labor and machining costs, and with multiple recycling uses of materials, than what has been produced with prior methods of joining shanks to heads, for manufacturing drill bits, slot drill bits, router bits, and similar rotary drilling and cutting tools, having common diameter shanks, such as shanks with diameters of about 0.125 inches, and with cutting diameters of 0.125 inches and smaller.

While a particular form of the invention has been illustrated and described, it will be apparent that various modifications can be made without departing from the sprit and scope of the invention. Accordingly, it is not intended that the invention be limited, except by the appended claims.

What is claimed is:

1. A method of manufacturing a carbide rotary drilling or cutting tool, comprising:
a. recovering a used tool having a working portion and a carbide shank, wherein the shank has a diameter of approximately 0.125 inches;
b. removing the working portion of the used tool;
c. attaching a carbide head to the shank, wherein the carbide head has a diameter of approximately 0.125 inches; and
d. machining the carbide head to create a new working portion having a diameter smaller than the shank diameter.

2. The method according to claim 1, wherein the used tool is a drill bit or a router bit.

3. The method according to claim 1, wherein the rotary drilling or cutting tool made by steps a-d is one of a drill bit and a router bit.

4. The method according to claim 1, wherein removing the working portion of the used tool comprises at least one of grinding, cutting, and heating to a sufficient temperature and pulling the working portion off.

5. The method according to claim 1, wherein the carbide head is attached to the shank by brazing.

6. The method according to claim 1, wherein the shank has a length of approximately 1-inch.

7. The method according to claim 1, wherein the carbide head has a length of approximately 0.5-1 inch.

8. The method according to claim 1, wherein machining the carbide head to create a new working portion comprises grinding.

9. A method of recycling used carbide tools and manufacturing new carbide tools therefrom, comprising:
a. recovering a used tool having a working portion and a carbide shank, wherein the shank has a diameter of approximately 0.125 inches;
b. removing the working portion of the used tool;
c. attaching a carbide head to the shank, wherein the carbide head has a diameter of approximately 0.125 inches;
d. grinding the carbide head to form a new tool having a new working portion with a diameter smaller than the shank diameter;
e. distributing the new tool for use; and
f. recovering the new tool after use for recycling in accordance with steps b-e above.

10. The method according to claim 9, wherein the used tool is a drill bit or a router bit.

11. The method according to claim 9, wherein the new carbide tool is a drill bit or a router bit.

12. The method according to claim 9, wherein removing the working portion of the used tool comprises at least one of grinding, cutting, and heating to a sufficient temperature and pulling the working portion off.

13. The method according to claim 9, wherein the shank has a length of approximately 1 inch.

14. The method according to claim 9, wherein the carbide head has a length of approximately 0.5-1 inch.

15. A method of recycling used carbide tools and manufacturing new carbide tools therefrom, comprising:
a. recovering a plurality of used carbide tools, each tool having a working portion and a carbide shank, and wherein each shank has a substantially constant diameter;
b. removing the working portions of the used tools, leaving only the shanks of said tools;
c. attaching a carbide head to each of the shanks, wherein the carbide heads have substantially the same diameter as the shanks;
d. machining the carbide heads to form new working portions and thus new carbide tools wherein the working portions have a diameter smaller than the shank diameter;
e. distributing the new carbide tools for use; and
f recovering the carbide tools after use for recycling in accordance with steps b-e above.

16. The method according to claim 15, wherein removing the working portions of the used tools comprises at least one of grinding, cutting, and heating to a sufficient temperature and pulling the working portion off.

17. The method according to claim 15, wherein the carbide head is attached to the shank by brazing.

18. The method according to claim 15, wherein the shanks have a length of approximately 1 inch and a diameter of approximately 0.125 inches.

19. The method according to claim 15, wherein the carbide heads have a length of approximately 0.5-1 inch and a diameter of approximately 0.125 inches.

20. The method according to claim 15, wherein the shanks and carbide heads have a diameter of approximately 2 mm.

21. The method according to claim 15, wherein the shanks and carbide heads have a diameter of approximately 3 mm.

22. The method according to claim 15, wherein the machining the carbide heads to form new working portions comprises grinding.

23. A rotary drilling tool, comprising:
a. a carbide shank having a diameter of approximately 0.125 inches;
b. a separate carbide working portion having a drilling diameter less than 0.125 inches;
c. ajoint connecting the shank to the working portion; and
d. wherein the tool is made by a process that comprises recovering previously used carbide tools to form at least the shank of the tool.

24. The drilling tool of claim 23, wherein the working portion is manufactured from the shank of a previously used carbide tool.

25. The drilling tool of claim 23, wherein the joint is formed by brazing.

26. A rotary routing tool, comprising:
a. a carbide shank having a diameter of approximately 0.125 inches;
b. a separate carbide working portion having a routing diameter less than 0.125 inches;
c. a joint connecting the shank to the working portion; and
d. wherein the tool is made by a process that comprises recovering previously used carbide tools to form at least the shank of the tool.

27. The routing tool of claim 26, wherein the working portion is manufactured from the shank of a previously used carbide tool.

28. The routing tool of claim 26, wherein the joint is formed by brazing.
